(19) United States
(12) Patent Application Publication
(10) Pub. No.: US 2026/0195486 A1
(43) Pub. Date: Jul. 9, 2026

(54) SERVICE PROVIDING METHOD THROUGH UTILIZING LARGE LANGUAGE MODEL

(71) Applicants: Tsung-Hsiu YU, Tainan City (TW); Chun-Ching WANG, Tainan City (TW); Shih-Wei CHEN, Kaohsiung City (TW)

(72) Inventors: Tsung-Hsiu YU, Tainan City (TW); Chun-Ching WANG, Tainan City (TW); Shih-Wei CHEN, Kaohsiung City (TW)

(21) Appl. No.: 19/192,887

(22) Filed: Apr. 29, 2025

(30) Foreign Application Priority Data
Jan. 6, 2025 (TW) 114100518

(51) Int. Cl. G06F 21/62; G06F 9/54

(52) U.S. Cl. CPC G06F 21/629; G06F 9/547; G06F 2209/544

(57) ABSTRACT

A service providing method implemented by a service system that includes a service server and a service intermediate terminal for providing application program interface (API) services, the service providing method includes: transmitting service usage specification data for input to a large language model (LLM) operating on a service request terminal to enable the LLM to generate a service request that includes identification data indicating a target API service to be accessed and input data for accessing the target API service, and transmit the service request to the service intermediate terminal, the target API service being one of the API services; and upon receiving the service request from the service intermediate terminal, accessing, by the service intermediate terminal, the target API service according to the identification data and inputting the input data to the target API service, so as to provide services.

### CROSS-REFERENCE TO RELATED APPLICATION

This application claims the benefits of Taiwanese Invention Patent Application No. 114100518, filed on Jan. 6, 2025, the entire disclosure of which is incorporated by reference herein.

### FIELD

The present disclosure relates to a service providing method, more particularly to a service providing method that provides service access specification to a large language model running on a service request terminal.

### BACKGROUND

With the rise in popularity of mobile devices, applications (hereinafter referred to as “apps”) have become more common. As long as a user connects their mobile device, such as a smart phone or a tablet computer, to an app platform through a network (e.g., the Internet), the user can download or purchase their desired apps anytime and anywhere. Food delivery orders, hospital registrations, taxi reservations, bus/train ticket purchases, and even online banking services can all be achieved through apps running on the mobile device, thereby providing great convenience to the user.

However, many people currently rely on various apps developed by each service provider to use individual services provided by each service provider. When a user wants to use a service provided by a particular service provider, the user first needs to download and install the app developed by the service provider before they can use their service. Moreover, whenever the service provider releases a new version of the app, the user needs to update the app to the latest version to ensure quality of service. Thus, this conventional method not only requires the user to download and install different apps to meet different service needs, the apps also need to be updated frequently to their latest versions. Therefore, there is still room for improvement in practical use.

### SUMMARY

Therefore, one object of the disclosure is to provide a service providing method that enables access to different services without needing to install and frequently update different software applications, therefore can greatly improve the convenience for users.

According to one aspect of the disclosure, a service providing method through utilizing a large language model is implemented by a service system that is connected to a service request terminal via a communication network. The service system includes a service server and a service intermediate terminal that is signally connected to the service server and that is used for providing a plurality of application program interface (API) services. The service providing method includes:
(A) transmitting, by the service server, service usage specification data for input to a large language model (LLM) operating on the service request terminal to the service request terminal for the LLM of the service request terminal to
   generate, based on a service request prompt that indicates service demand, the service usage specification data and an access prompt that indicates retrieval of the service usage specification data, a service request that includes identification data indicating a target API service to be accessed and input data for accessing the target API service, and
   transmit the service request to the service intermediate terminal,
the service usage specification data including function information indicating a function provided by the API services and access information indicating an access manner of the API services, the target API service being one of the API services; and
(B) upon receiving the service request from the service intermediate terminal, accessing, by the service intermediate terminal, the target API service according to the identification data and inputting the input data to the target API service, so as to provide services;
wherein the service request is outputted by the LLM as an API payload in a predetermined format.

According to another aspect of the disclosure, the service providing method is implemented by a storage server connected to a service request terminal via a communication network. The storage server includes a storage space for storing a plurality of pieces of to-be-paired service data. Each of the plurality of pieces of to-be-paired service data includes location information indicating the location of the provided service, authentication profile data and service content information indicating the provided service. The service access manner providing method includes the steps of:
(A) after receiving a service query request by the storage server, obtaining, by the storage server, at least one piece of candidate service data from among the plurality of to-be-paired service data based on the service query request, the service query request including at least one of
   requester location data indicating a location of a target service requester, and
   a service request content indicating a service to which the target service requester desires, wherein the storage server is programmed to obtain the at least one piece of candidate service data that satisfies the condition that a distance between a location of the service provider indicated by the location information included in the piece of to-be-paired service data and the location of the target service requester is less than a default distance, and that a provided API service indicated by the service content information included in the piece of to-be-paired service data corresponds with the service requested by the target service requester;
(B) obtaining, by the storage server, a service list according to the location information of the at least one candidate service data and the service content information and transmitting the same to the service request terminal, so as to make the service request terminal obtain a download request for downloading a target authentication profile data corresponding to a target service content information according to the service list and transmit the download request to the storage server, the target service content information being one of the service content information of the at least one content information of the at least one candidate service data; and
(C) after receiving the download request, transmitting, by the storage server, the target authentication profile data for input to a large language model that is running on the service request terminal to the service request terminal for enabling the LLM of the service request terminal to generate to-be-authenticated data according to the target authentication profile data.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a service platform to implement a service providing method according to an embodiment of the disclosure.

FIG. 2 is a flow chart illustrating a service matching process of the service providing method according to an embodiment of the disclosure.

FIG. 3 is a flow chart illustrating an authentication profile data obtaining process of the service providing method according to an embodiment of the disclosure.

FIG. 4 is a flowchart illustrating a service usage specification data obtaining process of the service providing method according to an embodiment of the disclosure.

FIG. 5 is a flow chart illustrating a service obtaining process of the service providing method according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics. Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

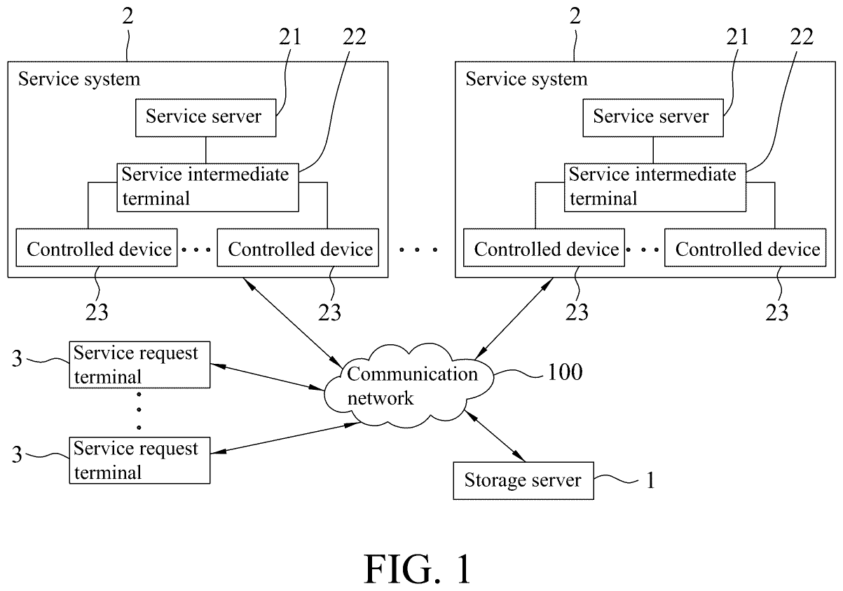

Referring to FIG. 1, an embodiment of a service platform is provided for implementing a service providing method of the present disclosure. The service platform includes a storage server 1, a plurality of service systems 2 connected to the storage server 1 via a communication network 100, and a plurality of service request terminals 3 connected to one of the service systems 2 via the communication network 100 and the storage server 1.

The storage server 1 includes a storage space for storing a plurality of pieces of to-be-paired service data related respectively to different services provided by a plurality of different service providers, respectively. The storage server 1 may be implemented using, for example, a network storage server or a cloud server. The communication network 100 may be the Internet, and each of the storage server 1, the service systems 2 and each of the service request terminals 3 may include hardware components that support wireless communication functions so as to communicate with one another.

Each service system 2 is established by one of the service providers for providing a service. Since each of the service systems 2 includes similar components and executes similar functions, only a single service system 2 is described herein. The service system 2 includes a service server 21, a service intermediate terminal 22 signally connected to the service server 21 and for providing multiple application program interface (API) services, and a plurality of controlled devices 23 signally connected to the service intermediate terminal 22. The service system 2 is used for providing service data of the service provided. The service data includes location information indicating a location of the service intermediate terminal 22, authentication profile data, and service content information indicating the application program interface (API) services. The service server 21 stores a plurality of pieces of identity identification information corresponding respectively to a plurality of different service requesters, and a plurality of pieces of operation permission information corresponding respectively to the plurality of pieces of identity identification information. The service intermediate terminal 22 is used to provide the API services. The service server 21 is implemented using, for example, a server or a cloud server. The service intermediate terminal 22 is implemented using, for example, an Internet of Things (IoT) gateway, which may be implemented using a Raspberry Pi single-board computer, an ESP32 chip microcontroller, a network-functional industrial computer, or an NVIDIA Jetson Orin Nano computer. In some embodiments, the service intermediate terminal 22 may be implemented using electronic components that are configured to communicate with APIs and configured to generate electrical signals. In general, the service intermediate terminal 22, and the communication between the service intermediate terminal 22 and each of the controlled devices 23 may be implemented using an inter-integrated circuit (I²C) or Modbus-compliant devices that are in compliance with Modbus protocol.

In some embodiments, the storage server 1 may support services such as API gateway, relaying API request message, etc.

In one embodiment, the service server 21 may be a computer associated with a hotel, the service intermediate terminal 22 may be an IoT gateway installed in the hotel, and the controlled devices 23 may be various electronic appliances disposed in the hotel such as a lamp, a television in a room, etc. Therefore, the service intermediate terminal 22 and the controlled devices 23 may be collectively referred to as an IoT system.

Each service request terminal 3 runs a large language model (LLM), which can be regarded as an artificial intelligence assistant. Specifically, in some embodiments, the service request terminal 3 executing the LLM is configured to decode API specifications. In this embodiment, the service request terminals 3 are held by multiple service requesters, respectively. Since each of the service request terminals 3 includes similar components and executes similar functions only one service request terminal 3 is described herein. Any one of the service requesters can transmit a service query request via their service request terminal 3 for obtaining a service he/she requested, and is referred to as a “target service requester” thereafter. The service request terminal 3 may be implemented using, for example, an AI device such as AI PIN or Rabbit R1, a smart glass, or an AI smartphone.

Details of the operations of the service platform will be described below by embodiments of the service providing method of the present disclosure. The present embodiment of the service providing method sequentially includes a service matching process, an authentication profile data obtaining process, a service usage specification data obtaining process and a service obtaining process.

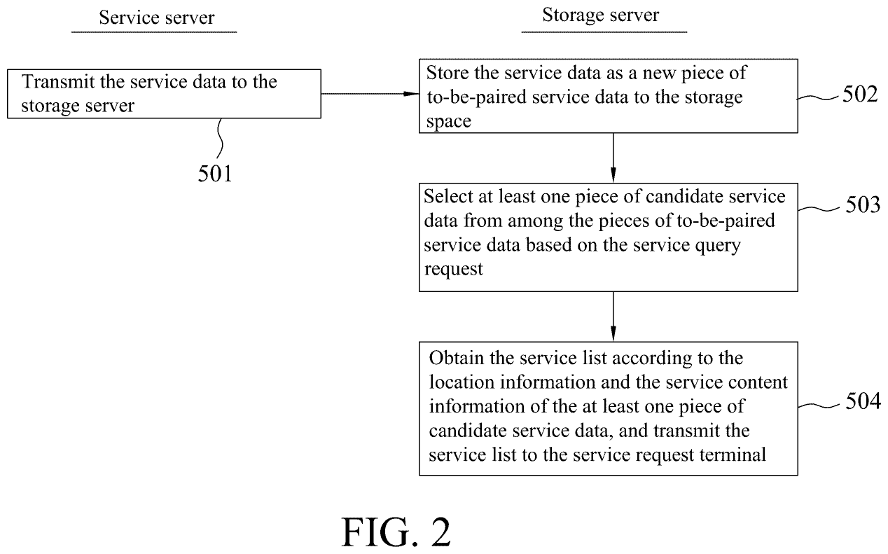

Referring to FIG. 1 and FIG. 2, the service matching process describes how to obtain a service list, and includes the following steps.

In step 501, the service server 21 transmits the service data to the storage server 1. The service data includes the location information, the authentication profile data and the service content information. The authentication profile data includes authentication manner information that indicates an authentication manner, and an access prompt that indicates retrieval of service usage specification data. The authentication manner may be, for example, authenticating with the authentication procedure of Open Authorization in an authentication website built in the service server 21.

For example, if the service provider is a bed and breakfast (BNB) operator, the service provided by the bed and breakfast operator relates to accommodation, and the service intermediate terminal 22 may be a hotel equipment host terminal implemented by Raspberry Pi. The provided API services may, for example, include an API service related to room lock control of a BNB, an API service related to light control of the BNB, and an API service related to air conditioner control of the BNB. If the service provider is a vending machine vendor and the service provided by the vending machine vendor is related to the vending machine, the service intermediate terminal 22 may be a vending machine outlet and display panel controller implemented using a microcontroller, and the API services may include, for example, an API service related to beverage control of a vending machine and an API service related to ingredient control of the vending machine. If the service provider is a supplier and the service provided by the supplier is related to supplying products, the service intermediate terminal 22 may be a production line controller implemented by an industrial computer, the API services may include, for example, an API service for controlling a production line. If the service provider is a drone/robot provider and the service provided by the drone/robot provider is related to a drone/robot, the service intermediate terminal 22 may be a flight traffic/behavior automatic navigation system implemented by an industrial computer, and the API services may include, for example, an API service related to a drone/robot control.

In step 502, after the storage server 1 receives the service data from the service server 21, the storage server 1 stores the service data as a new piece of to-be-paired service data to the storage space.

In step 503, after the storage server 1 receives a service query request from the service request terminal 3, the storage server 1 selects at least one piece of candidate service data from among the pieces of to-be-paired service data based on the service query request. Specifically, the service query request includes requester location data indicating a location of a target service requester who is holding the service request terminal 3, and service request content indicating a service that the target service requester desires to obtain. For each piece of to-be-paired service data, the storage server 1 is programmed to select the piece of to-be-paired service data as one piece of candidate service data if the piece of to-be-paired service data satisfies the condition that a distance between a location of the service provider indicated by the location information included in the piece of to-be-paired service data and the location of the target service requester is less than a default distance, and that a provided API service indicated by the service content information included in the piece of to-be-paired service data corresponds with the service requested by the target service requester. For example, in the case that the service requested by the target service requester indicated by the service query request is accommodation, the storage server 1 may obtain at least one piece of candidate service data associated with accommodation within the default distance from the location of the target service requester (such as hotels within three kilometers from the target service requester). It should be noted that in other embodiments, the service query request may also include only the requester location data or only the service request content. In such embodiments, depending on the content included in the service query request, the at least one piece of candidate service data satisfying the location of the service provider and the location of the target service requestor may be less than a default distance or the provided service matches the service that the target service requestor desires to obtain is obtained. It is noted that the default distance may be a preset distance, or a distance set by the target service requestor.

In step 504, the storage server 1 obtains the service list according to the location information and the service content information of the at least one piece of candidate service data, and transmits the service list to the service request terminal 3.

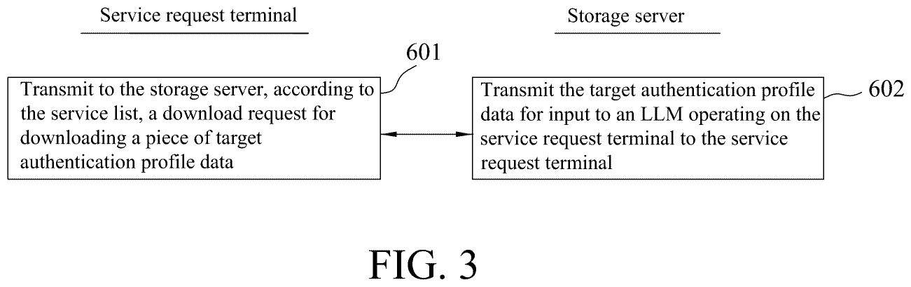

Referring to FIG. 1 and FIG. 3, the authentication profile data obtaining procedure illustrates how to obtain the authentication profile data, and includes the following steps.

In step 601, the service request terminal 3 transmits to the storage server 1, according to the service list, a download request for downloading a piece of target authentication profile data corresponding to a piece of target service content information. The target service content information is one of the service content information of the at least one piece of candidate service data.

In step 602, after receiving the download request, the storage server 1 transmits the target authentication profile data for input to an LLM operating on the service request terminal 3 to the service request terminal 3.

It should be noted that, in this embodiment, the target authentication profile data is obtained from the storage server 1. However, in other implementations, the target authentication profile data may also be obtained from the service server 21 that provides the service corresponding to the target service content information. At this time, the service request terminal 3 transmits a discover signal to the service server 21 via local wireless broadcast, so that the service server 21 transmits the target authentication profile data to the service request terminal 3 in response to the discover signal.

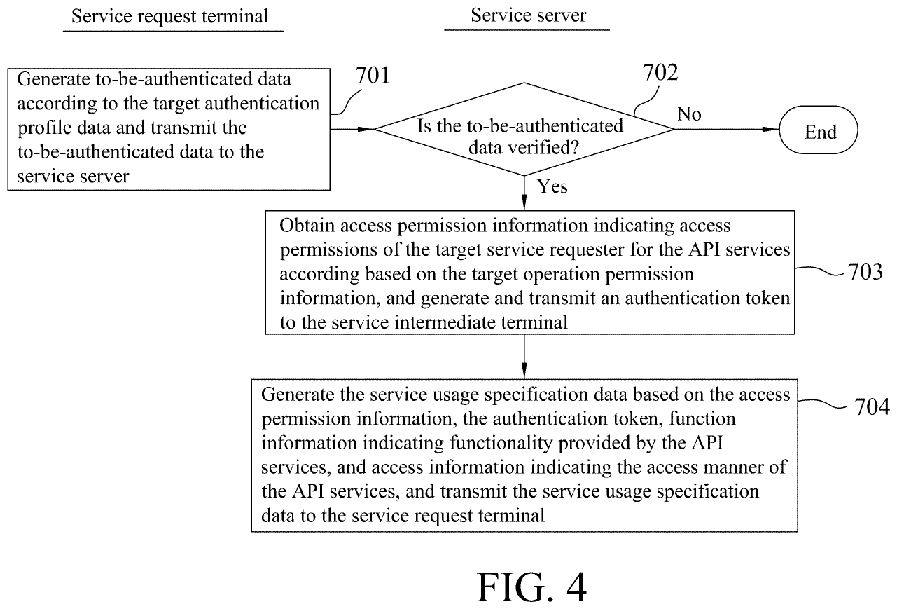

Referring to FIG. 1 and FIG. 4, the service usage specification data obtaining procedure illustrates how to obtain the service usage specification data includes the following steps.

In step 701, the LLM of the service request terminal 3 generates to-be-authenticated data according to the target authentication profile data and transmits the to-be-authenticated data to the service server 21. The to-be-authenticated data is related to target identity identification information of the target service requester corresponding to the service request terminal 3. It is noted that the target identity identification information refers to the identity identification information of the target service requester.

In step 702, after receiving the to-be-authenticated data, the service server 21 verifies the to-be-authenticated data. When the service server 21 successfully verifies the to-be-authenticated data, the flow proceeds to step 703. When the service server 21 cannot successfully verify the to-be-authenticated data, the flow ends. It is noted that the verification of the to-be-authenticated data may be done using existing techniques, and details thereof are omitted herein for the sake of brevity.

In step 703, the service server 21 further obtains a target operation permission information corresponding to the target identity identification information based on the target identity identification information related to the to-be-authenticated data, obtains access permission information indicating access permissions of the target service requester for the API services according based on the target operation permission information, and generates and transmits an authentication token to the service intermediate terminal 22.

It is worth mentioning that, taking the aforementioned accommodation service as an example, the target service requester may reserve the room via a website or other ways in advance, so that the service server 21 may pre-store the identity identification information of the target service requester and the corresponding operation permission information thereof as, for example, the door lock, lights and air conditioning of the reserved room, thereby enabling the service server 21 to obtain the access permission information according to the target operating authority information.

Exemplary access permission information for an API service to control a light in a room (e.g. the room 001) reserved by the target service requester is provided below. As can be seen, the access permission information indicates that the only lights that can be controlled by the target service requester in the hotel are those in the reserved room ROOM001.

```
{ ″Vars″: [
    { ″VarsName″: ″light1″, ″VarsComment″:
″balcony lights of Room001″ },
    { ″VarsName″: ″light2″, ″VarsComment″:
″master bedroom light of Room001″ },
    { ″VarsName″: ″light3″, ″VarsComment″:
″restroom light of Room001″ },
    { ″VarsName″: ″light4″, ″VarsComment″:
″kitchen light of Room001″ },
    { ″VarsName″: ″light5″, ″VarsComment″:
″living room main light of Room001″ }
  ] }
```

In step 704, the service server 21 generates the service usage specification data based on the access permission information, the authentication token, function information indicating functionality provided by the API services, and access information indicating the access manner of the API services, and transmits the service usage specification data to the service request terminal 3. The function information and the access information are pre-defined information based on information that the functions provided by the API services.

```
{
  ″api_version″: ″1-2-23″,
  ″api_method″: ″POST″,
  ″api_destination_url″:
″https://demoserv.ai/api?version=1-2-23″
}
″api_list_for_user″: {
  ″api_service_comment″: ″the client can call
exactly one function for each api call.″,
  ″apis″: [
    {
      ″api_function″: ″change_lightstate″,
      ″api_comment″: ″This function can turn on
or off the specified light. The name of the light
and, the status of the light and the version of
the API need to be used as function parameters.
Related information is in the environment
variable table, which can be obtained with
get_vars function.″,
      ″api_argument1″: ″string lightname″,
      ″api_argument1_comment″: ″The name
(VarsName) of the light you want to control.
Related information is in the environment
variable table. ″,
      ″api_argument2″: ″bool
tryChangeLightStatus″,
      ″api_argument2_comment″: ″false: turn-off
the light, true: turn-on the light.″,
      ″api_argument3″: ″string api_version″,
      ″api_argument3_comment″: ″API version name.
Set this specification version as parameter
content. This is to verify whether the API
version is correct.″
    },
    {
      ″api_function″: ″get_vars″,
      ″api_argument1″: ″AuthToken
user_auth_token″,
      ″argument1_comment″: ″Your auth token. This
authentication token is provided by the system
APP when you log in.″,
      ″return_value″: ″List<string VarsName,
string VarsComment> vars″,
      ″return_value_comment″; ″Get the
environment variable table, which lists the light
numbers you have control over and their uses.″
    }
  ]
}
```

Taking the aforementioned API services for controlling lights as an example, exemplary functional information and access information of functions provided by API services for controlling the lights are provided above.

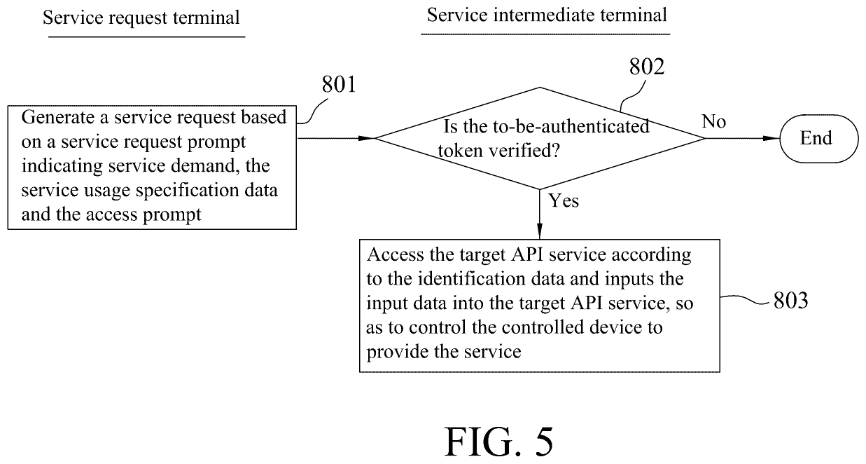

Referring to FIG. 1 and FIG. 5, the service obtaining procedure illustrates how to obtain a service provided by the service provider and includes the following steps.

In step 801, after receiving the service usage specification data, the LLM of the service request terminal 3 generates a service request based on a service request prompt indicating service demand, the service usage specification data and the access prompt. The service request includes identification data indicating a target API service to be accessed and input data for accessing the target API service. Then, the service request terminal 3 transmits the service request and a to-be-authenticated token to the service intermediate terminal 22. The service request prompt is generated by input operations of the target service requester. It is noted that in different embodiments, the target service requester may input the service request prompt using different manners. For example, in some cases, the target service requester may operate the service request terminal device 3 to manually input texts as the service request prompt. In some cases, the target service requester may orally speak the service request prompt, which may be received and transformed by the service request terminal device 3 into texts.

An exemplary access prompt that is for use by the service request terminal device 3 is provided below. The exemplary access prompt may be pre-obtained from the storage server 1 and stored in the service request terminal device 3.

<purpose>EXCLUSIVELY output a JSON string as the
payload of an API function call which fulfills
user's intent in content.</purpose>
<instruction>You are an API assistant and can
strictly follow the following steps: 1. You need
to check the API usage specification; 2. You need
to compare the user's intent in content to find
out which API should be used; 3. According to the
user's intent, you need to compare the comments
to determine the JSON format of the API
parameters that need to be called. 4. You need to
submit this API parameter field in JSON format to
the user in text form without adding any other
text description or response. 5. Reference the
example below. 6. Whenever you cannot confirm the
user's needs, or cannot find the corresponding
API in the specification, you should reply with
″No matched API found″.</instruction>
<API-usage-specification> {{spec_doc}}
</API-usage-specification>
<environment-variable-table> {{vars_doc}}
</environment-variable-table>
<example>
<example-prompt> {{exp_prompt_doc}} </example-
prompt>
<example-output> {{exp_result_doc}} </example-
output>
</example>
<content>{{user_prompt}}</content>

Generally, the service request prompt is inputted by one of the service requesters operating one of the service request terminals 3, and the access prompt, combined with the service request prompt, causes the LLM of the service request terminal 3 to generate the service request as an API payload in a predetermined format (e.g., JSON, Extensible Markup Language (XML), x-protobuf, etc.). In general, the term “API payload” refers to data transmitted between a client and server during a request or response. As such, the service requester may simply input the service request prompt in plain language, and the LLM is able to output data in the suitable format for the service intermediate terminal 22 to be able to “read” the service request and to control the controlled device 23.

For example, the service request prompt may be inputted by one of the service requesters operating one of the service request terminals 3, and contains the text of “turn on a light in the living room”, and the LLM of the service request terminal 3 generates the following service request as an API payload in the JSON format as shown below.

```
POST https://demoserv.ai/api?version=1-2-23
Content-Type: application/json
{
  ″api_function″: ″change_lightstate″,
  ″lightname″: ″light5″,
  ″tryChangeLightStatus″: true,
  ″api_version″: ″1-2-23″
}
```

It is worth noting that, in the case that the service request terminal 3 supports Action Model technology, that is, the service request terminal 3 directly transmits the service request as shown above to the service intermediate terminal 22. However, when the service request terminal 3 does not support Action Model technology, the service request terminal 3 adds a website address of the service intermediate terminal 22 to the service request, repackages the service request into a JSON format, and transmits the service request to a relay cloud server (not shown in the drawings), such that relay server is programmed to transmit the service request to the service intermediate terminal 22 indicated by the website address. An exemplary service request transmitted by the service request terminal 3 to the relay cloud server is provided below.

```
POST https://APIrelay.demo.com/serviceId=6A37
Content-Type: application/json
{
  ″http-request-url″: ″https://demoserv.ai/api?version=1-2-23″,
  ″http-request-data″: {
    ″api_function″: ″change_lightstate″,
    ″lightname″: ″5″,
    ″tryChangeLightStatus″: true,
    ″api_version″: ″1-2-23″
  }
}
```

In step 802, after receiving the service request and the to-be-authenticated token at the service intermediate terminal 22, the service intermediate terminal 22 verifies the to-be-authenticated token. When the service intermediate terminal 22 successfully verifies the to-be-authenticated token, the flow proceeds to step 803. When the service intermediate terminal 22 fails to successfully verify the to-be-authenticated token, the procedure ends. It is noted that the verification of the to-be-authenticated token may be done using existing techniques, and details thereof are omitted herein for the sake of brevity.

In step 803, the service intermediate terminal 22 accesses the target API service according to the identification data and inputs the input data into the target API service, so as to control the controlled device 23 to provide the service. It should be noted that the service intermediate terminal 22 transmits a control command to a corresponding one of the controlled devices 23 by calling the target API service. Continuing the aforesaid examples, the service intermediate terminal 22 turns on the living room light by calling the target API service to send the control command to the living room light (i.e., the controlled device 23).

In summary, the service providing method of the present disclosure transmits the service data to the storage server 1 by the service server 21. Accordingly, the service information of the service provider may be disclosed on a network service for facilitating retrieval. In addition, the LLM running on the service request terminal 3 automatically parses a target API service to be accessed according to the service usage specification data, and generates input data required to access the target API service. As such, as long as the service usage specification data is provided to the service request terminal 3, the service request can be generated through the LLM of the service request terminal 3 to access the service, and service can be used without downloading an installed APP and completely updating the APP. Further, performing authentication through the target authentication profile data may increase security of using the service. Also, the access permission information indicating access permission of the target service requester to the API services is obtained through the target operation permission information to hide service content that the target service requester cannot use to govern access authority of the target service requester. Therefore, the object of this disclosure is achieved.

It is noted that the embodiments of the service providing method as described in the disclosure further provides the following advantages over the existing technologies: (1) the location of the service provider indicated by the location information included in the candidate service data and the location of the target service requester are taken into consideration in determining the service list. That is, the target service requester may easily obtain service within a default distance; (2) the configuration of the service platform enables that the service request terminal 3 does not require up-to-date API service specifications compliant with every service intermediate terminal 22, since the service request terminal 3 is configured to communicate with the storage server 1 to obtain API service specifications therefrom. As such, even though the API service specifications for different service intermediate terminals 22 may be frequently updated, the target service requester does not need to also frequently update the software applications installed on the service request terminal 3 used for implementing the service providing method; (3) the LLM that runs on the service request terminal 3 in the service providing method is designed to have a relatively smaller complexity, is therefore able to be run on a mobile device such as a smartphone, and enables the target service requester to operate the service request terminal 3 to control the IoT system; and (4) the structure of the service platform enables easy integration of additional API services for the target service requester to access. In one example, after a change of one specific API service specification is implemented, one software engineer is able to use github-copilot with an LLM (e.g., o4-mini provided by OpenAI©) to complete the corresponding changes required.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A service providing method through utilizing a large language model to be implemented by a service system that is connected to a service request terminal via a communication network, the service system including a service server and a service intermediate terminal that is signally connected to the service server and that is used for providing a plurality of application program interface (API) services, the service providing method comprising:
(A) transmitting, by the service server, service usage specification data for input to a large language model (LLM) operating on the service request terminal to the service request terminal for the LLM of the service request terminal to
generate, based on a service request prompt that indicates service demand, the service usage specification data and an access prompt that indicates retrieval of the service usage specification data, a service request that includes identification data indicating a target API service to be accessed and input data for accessing the target API service, and
transmit the service request to the service intermediate terminal,
the service usage specification data including function information indicating a function provided by the API services and access information indicating an access manner of the API services, the target API service being one of the API services; and
(B) upon receiving the service request from the service intermediate terminal, accessing, by the service intermediate terminal, the target API service according to the identification data and inputting the input data to the target API service, so as to provide services;
wherein the service request is outputted by the LLM as an API payload in a predetermined format.

2. The service providing method as claimed in claim 1, further comprising, prior to step (A), the steps of:
(C) transmitting, by the service server, authentication profile data for input to the LLM operating on the service request terminal to the service request terminal for the LLM of the service request terminal to generate, according to the authentication profile data, to-be-authenticated data and to transmit the to-be-authenticated data to the service server, the authentication profile data including authentication manner information indicating an authentication manner;
(D) after receiving the to-be-authenticated data, verifying, by the service server, the to-be-authenticated data; and
(E) in response to successfully verifying the to-be-authenticated data by the service server, executing step (A).

3. The service providing method as claimed in claim 2, wherein in step (C), the access prompt is included in the authentication profile data.

4. The service providing method as claimed in claim 2, the service server further storing a plurality of pieces of identity identification information corresponding to a plurality of different service requesters, respectively, and a plurality of pieces of operation permission information corresponding to the plurality of pieces of identity identification information, respectively, wherein:
in step (C), the to-be-authenticated data is related to the identity identification information of a target service requester corresponding to the service request terminal;
in step (E), when the service server successfully verifies the to-be-authenticated data, the service server further obtains a target operation permission information corresponding to the target identity identification information based on the target identity identification information related to the to-be-authenticated data, and obtains, access permission information indicating access permission of the target service requester for the API services based on the target operation permission information; and
in step (A), the service usage specification data further includes the access permission information that indicates access permissions of the API services.

5. The service providing method as claimed in claim 2, wherein:
in step (E), when the service server successfully verifies the to-be-authenticated data, the service server further generates a to-be-authenticated token and transmits the same to the service intermediate terminal; and
in step (A), the service usage specification data further includes the to-be-authenticated token, and the service request further includes the to-be-authenticated token.

6. The service providing method as claimed in claim 5, wherein step (B) includes the sub-steps of:
(B-1) after receiving the service request and the to-be-authenticated token, verifying, by the service intermediate terminal, the to-be-authenticated token; and
(B-2) when the service intermediate terminal successfully verifies the to-be-authenticated token, accessing, by the service intermediate terminal, the target API service according to the identification data and entering the input data into the target API service to provide services.

7. The service providing method as claimed in claim 1, the service system being further signally connected to a storage server that includes a storage space for storing a plurality of pieces of to-be-paired service data, prior to step (A), further comprising the steps of:
(F) transmitting, by the service server, service data to the storage server, the service data including location information indicating the location of the service intermediate terminal, an authentication profile data and service content information indicating a service provided by the application interface services, so that the storage server stores the service data as a new piece of to-be-paired service data to the storage space, and transmits the authentication profile data for input to the LLM running on the service request terminal to the service request terminal in response to a download request from the service request terminal.

8. The service providing method as claimed in claim 1, the service system being further signally connected to a relay cloud server, wherein step (A), the service request terminal transmits the service request to the relay cloud server so as to enable the relay cloud server to transmit the service request to the service intermediate terminal.

9. A service providing method, implemented by a storage server connected to a service request terminal via a communication network, the storage server including a storage space for storing a plurality of pieces of to-be-paired service data, each of the plurality of pieces of to-be-paired service data including location information indicating the location of the provided service, authentication profile data and service content information indicating the provided service, the service access manner providing method comprising the steps of:
(A) after receiving a service query request by the storage server, obtaining, by the storage server, at least one piece of candidate service data from among the plurality of to-be-paired service data based on the service query request, the service query request including at least one of
requester location data indicating a location of a target service requester, and
a service request content indicating a service to which the target service requester desires, wherein the storage server is programmed to obtain the at least one piece of candidate service data that satisfies the condition that a distance between a location of the service provider indicated by the location information included in the piece of to-be-paired service data and the location of the target service requester is less than a default distance, and that a provided API service indicated by the service content information included in the piece of to-be-paired service data corresponds with the service requested by the target service requester;
(B) obtaining, by the storage server, a service list according to the location information of the at least one candidate service data and the service content information and transmitting the same to the service request terminal, so as to make the service request terminal obtain a download request for downloading a target authentication profile data corresponding to a target service content information according to the service list and transmit the download request to the storage server, the target service content information being one of the service content information of the at least one content information of the at least one candidate service data; and
(C) after receiving the download request, transmitting, by the storage server, the target authentication profile data for input to a large language model that is running on the service request terminal to the service request terminal for enabling the LLM of the service request terminal to generate to-be-authenticated data according to the target authentication profile data.

10. The service providing method as claimed in claim 9, the storage server being further connected to a service server via a communication network, prior to step (A), further comprising the steps of:
(D) after the storage server receives service data from the service server, storing, by the service server, the service data as a new piece of to-be-paired service data in the storage space, the service data including a location information indicating a location of the service provided by the service server, authentication profile data corresponding to the service server and service content information indicating the service provided by the service server.
